(19) United States
(12) Patent Application Publication
(10) Pub. No.: US 2006/0117662 A1
(43) Pub. Date: Jun. 8, 2006

(54) Revolving door drive mechanism for a door having at least one leaf

(76) Inventor: Sven Busch, Dortmund (DE)

Correspondence Address: COHEN, PONTANI, LIEBERMAN & PAVANE, 551 FIFTH AVENUE, SUITE 1210, NEW YORK, NY, 10176, US

(21) Appl. No.: 10/559,267

(22) PCT Filed: May 26, 2004
(86) PCT No.: PCT/EP04/05628

§ 371 Date: Jan. 11, 2006

(30) Foreign Application Priority Data
Jun. 2, 2003 (DE) 103250271

(51) Int. Cl. E05D 15/02

(52) U.S. Cl. 49/42

(57) ABSTRACT

A revolving door drive for a door includes an electrohydraulic drive unit actuating at least one door leaf.

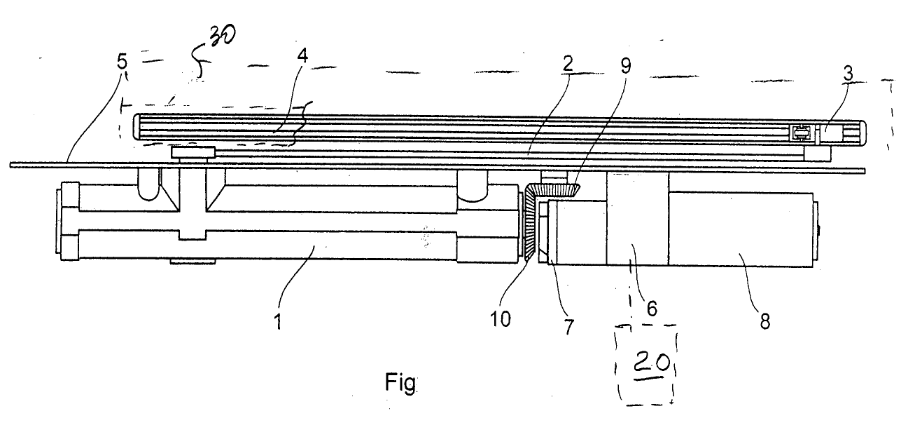

The invention pertains to a revolving door drive for a door with at least one leaf, the leaves of which can be moved by a door closer in the opening and closing directions, where the door closer can be driven by a drive unit.

Automatic door drives have the purpose of making it easier to pass through doors. The use of automatic door drives is growing not only in public and commercial spaces such as administration buildings, hospitals, and nursing homes, but also increasingly in homes for the handicapped. The door drives are always mounted on the door leaf or above the door frame.

The problem with door drives of this type is that measures to accommodate them must be included in the original plans for the building.

It is therefore the task of the present invention to create an automatic revolving door drive which is very small and inconspicuous, so that it will not negatively affect the architectural impression of the door, and which can also be produced inexpensively and is nearly maintenance-free.

This task is accomplished by the features indicated in claim 1. Advantageous elaborations can be derived from the subclaims.

Because the drive unit is designed as an electrohydraulic drive unit, an especially small revolving leaf drive can be created, which can be also be installed in a concealed manner in the door or in the door frame.

According to an advantageous elaboration, the electrohydraulic drive unit has a hydraulic connection block, a DC motor, and a pump.

Especially when, in accordance with another embodiment, the DC motor is designed as an air-core motor and the pump as an internal gear pump, an especially small and quiet door drive can be obtained, which can be installed invisibly inside the door or frame.

Installation can be concealed even more effectively when, in an advantageous elaboration, the oil flow between the pump or the hydraulic connection block and the door closer passes through a mounting plate, which carries the door drive and the hydraulic drive unit. Thus the entire revolving leaf drive can be produced and installed as a single unit without the need to install any additional hydraulic lines.

To adjust the spring force of the door closer, it is advantageous to mount a first gear wheel on the mounting plate and a second gear wheel on the door closer so that the two gear wheels mesh with each other.

The two gear wheels preferably have spur teeth, so that force can be transferred reliably in the smallest possible amount of space.

A piston accumulator is provided to compensate for changes in volume.

Because the door closer, the pump, the hydraulic connection block, and the DC motor are situated in a row, one behind the other, a small, very narrow revolving leaf drive can be realized.

If, in accordance with another advantageous elaboration, the door closer, the pump, the hydraulic connection block, and the DC motor are designed as replaceable modules, the ease of maintaining the revolving leaf drive according to the invention can be improved even more.

If one end of an actuating lever is mounted on the door closer and the other end is connected to a sliding piece, which is free to slide along a slide rail installed inside the door or frame, an especially simple, space-saving, and nearly invisible power feed is obtained, the power being supplied through the slide rail and the actuating lever.

Because, in accordance with an advantageous embodiment, the inventive revolving door drive has a maximum width of 40 mm, a maximum height of 50 mm, and a maximum length of 500 mm, the revolving leaf drive is especially suitable for concealed installation.

Additional features and advantages of the invention can be derived from the following description of a preferred exemplary embodiment.

The single FIGURE shows a schematic diagram of an inventive revolving leaf drive.

In the diagram, only the relevant parts are presented; all other design elements have been omitted for the sake of clarity.

An inventive revolving leaf drive has a door closer 1, which can have a cam drive or a gear drive. The door closer 1 is connected to an actuating lever 2, which is connected at its other end to a slide piece 3, which is free to slide in a slide rail 4, installed inside a door or door frame.

The door closer 1 is fastened to a mounting plate 5, which also carries a hydraulic connection block 6. A pump 7, preferably designed as an internal gear pump, and a DC motor 8, preferably designed as an air-core motor, are attached to the connection block 6.

The door closer 1, the pump 7, the hydraulic connection block 6, and the DC motor 8 are mounted in a row on the mounting plate 5 and are designed as a individual, replaceable modules.

To adjust the spring force, a first gear wheel 9 is mounted on the mounting plate 5, this first gear wheel meshing with a second gear wheel 10, which is mounted, for example, at the end of the door closer 1 facing the pump 7. The two gear wheels 9, 10 are provided with spur teeth.

The oil flow between the pump 7, i.e., the hydraulic connection block 6, and the door closer 1 can proceed via the mounting plate 5, into which appropriate lines or channels are machined. In addition, a piston accumulator (not shown) is provided to compensate for changes in volume. It is also conceivable that the hydraulic lines could be installed on the mounting plate 5.

The inventive revolving leaf drive has a maximum width of 40 mm, a maximum height of 50 mm, and a maximum length of 500 mm.

The transmission of power to the inventive revolving leaf drive can proceed invisibly, for example, through the slide rail 4 and the actuating lever 2. The control unit can be external, or it can be concealed in the frame or in the door.

An end-position detection function can also be provided through the use of switches or reed contacts in the slide rail, and the position and movement of the leaf can be detected by a “tensile position sensor”.

### LIST OF REFERENCE NUMBERS

1 door closer
2 actuating lever
3 slide piece
4 slide rail
5 mounting plate
6 hydraulic connection block
7 pump
8 DC motor
9 gear wheel
10 gear wheel

1.-13. (canceled)

14. A revolving door drive for a door comprising at least one leaf, the revolving door drive comprising:
a door closer configured to displace the at least one leaf in opposite opening and closing directions; and
an electrohydraulic drive unit coupled to the door closer and operable for actuating the door closer.

15. The revolving door drive of claim 14, wherein the electrohydraulic drive unit comprises:
a pump operable for delivering hydraulic fluid,
a DC motor coupled to and operable for actuating the pump, and
a hydraulic connection block (6) in flow communication with the pump.

16. The revolving door drive of claim 15, wherein the DC motor is an air-core motor.

17. The revolving door drive of claim 15, wherein the pump is an internal gear pump.

18. The revolving door drive of claim 15, further comprising a mounting plate supporting the door closer and the electrohydraulic drive unit, the mounting plate being configured to provide flow communication between the electrohydraulic unit and the door closer.

19. The revolving door drive of claim 18, further comprising a first gear wheel and a second gear wheel mounted to the mounting plate and to the door closer, respectively, and meshing with one another.

20. The revolving door drive of claim 19, wherein the first and second gear wheels each are toothed wheels.

21. The revolving door drive of claim 15, further comprising a piston accumulator in flow communication with the electrohydraulic unit and operable for compensating a volume of the hydraulic fluid deliverable by the electrohydraulic unit.

22. The revolving door drive of claim 15, wherein the DC motor, the pump, the hydraulic connection block, and the door closer are installed in a row.

23. The revolving door drive of claim 15, wherein the door closer, the pump, the hydraulic connection block, and the DC motor are detachably coupled to one another and selectively replaceable.

24. The revolving door drive of claim 14, further comprising
a slide rail mounted inside the door or a door frame;
an actuating lever having
one end mounted to the door closer, and
an opposite end coupled to the slide rail; and
a slide piece slidable along the slide rail.

25. The revolving door drive of claim 24, further comprising a means for powering the electrohydraulic unit, the slide rail and the actuating lever being configured to accommodate the means for powering.

26. The revolving door drive of claim 14, wherein the revolving door drive is configured to have a maximum width of about 40 mm, a maximum height of about 50 mm, and a maximum length of about 500 mm.
